(19) United States
(12) Patent Application Publication
(10) Pub. No.: US 2008/0181994 A1
(43) Pub. Date: Jul. 31, 2008

(54) Apparatus and Method for Vacuum Microwave Drying of Food Products

(75) Inventors: Christopher John Cornwell, Little Elm, TX (US); William Cartwright Weller, McKinney, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 11/668,838

(22) Filed: Jan. 30, 2007

(51) Int. Cl. A23L 1/025; H05B 6/64

(52) U.S. Cl. 426/242; 99/451

(57) ABSTRACT

The present invention discloses an improved apparatus and method for making a vacuum microwaved food product on a commercial scale. The invention discloses a rotatable carousel having an annular region for a food product for placement into a vacuum microwave. Food products such as strawberries can be placed into the annular region and dehydrated in a vacuum microwave.

### BACKGROUND OF THE INVENTION

1. Technical Field

The present invention relates to an improved apparatus and method for making a vacuum microwaved snack food.

2. Description of Related Art

Processed snack foods are generally provided to the consumer in a ready-to-eat form. Such snack foods include a wide variety of foods such as potato chips, corn chips, puffed dough articles, cookies and crackers. Processed snack foods are frequently made from wheat, corn, potato, or other starch-containing ingredients that are deep fat fried. For example, potato chips are prepared by frying thin slices of raw, fresh potatoes.

Savvy consumers have become increasingly health conscious, resulting in an increased demand for healthier, less processed and more natural snack foods. Recent polls have shown that consumers want to try to control the amount of fat in their diet. Further, consumers increasingly regularly or sometimes check nutritional labels for fat content. In many cases, the top barrier to people eating more snack food is the perception that the food is unhealthy. This is supported by the fact that about 59% of consumers believe that baked products are healthy as compared to about 11% who believe that fried foods are healthy. Consequently, a need exists for lower fat snack foods that consumers deem to be healthier.

While artificial or non-natural ingredients have been used to lower the fat content of snack foods, many consumers also have an aversion to such ingredients. For example, consumers increasingly say they prefer foods that are natural and many say they avoid products that contain a high proportion of artificial ingredients or preservatives. Most consumers say they believe food of natural origin is good for their health as opposed to those who say they believe artificial foods are good for their health. Consequently, a need exists for a low-fat snack food having few or no artificial ingredients or preservatives.

Unfortunately, it has proven difficult to make desirable, low-fat shelf-stable snack foods from natural, raw ingredients on a commercial scale. Some proposed solutions to providing more natural shelf-stable snack foods are illustrated by U.S. Pat. Nos. 5,676,989, 5,962,057, and 6,312,745, all directed towards the vacuum microwaving of food products. Such patents, however, fail to disclose a way to make such food products on a commercial scale.

Rotary vacuum microwaves have been used in non-food applications. FIG. 1 is a simplified cross-section of a prior art rotary vacuum microwave having a non-food granular-type material. As the rotary drum within a microwave cavity rotates in the direction 18 shown by the arrow, the product 12 tends to migrate up the drum wall until it reaches a point where gravity forces the product to tumble down towards the bottom of the drum. Relatively high volume rotary tumbler vacuum microwave dryers damage foods such as fruits and vegetables due to collisions during this tumbling process. Further, because the moisture being produced at the surface of the food during dehydration can make the foods sticky, clumping is also a problem. Thus, food products that are vacuum microwaved are typically placed into in a monolayer configuration. A monolayer configuration, however, is often inefficient and uneconomical because such configuration significantly reduces the capacity or throughput of product, especially in a batch configuration. Consequently, a need exists for an improved method and apparatus to increase efficiency of the vacuum dehydration of food products.

### SUMMARY OF THE INVENTION

The proposed invention comprises a method and apparatus for making a low-fat, shelf-stable, ready-to-eat snack food from raw food ingredients. In one embodiment, the method comprises the steps of providing a raw plant-based food, placing the food into an annular region of rotatable carousel, and dehydrating the food in a vacuum microwave as the carousel rotates.

In one embodiment, the present invention is directed towards an apparatus that can be used to dehydrate a raw food product in a vacuum microwave to make a snack food. The apparatus comprises a rotatable carousel having an annular region for placing a food product. The rotatable carousel can be placed into a microwave under vacuum conditions and rotated during the operation of the microwave. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a simplified cross-section of a prior art rotary vacuum microwave having a product;

FIG. 2 is an exploded simplified cut-away perspective view of a carousel having a plurality of compartments in an annular region and a vacuum microwave in accordance with one embodiment of the present invention; and

FIG. 3 is a cut away side view of a vacuum microwave having a carousel that rotates about the transverse axis of the vacuum microwave drum in accordance with one embodiment of the present invention.

### DETAILED DESCRIPTION

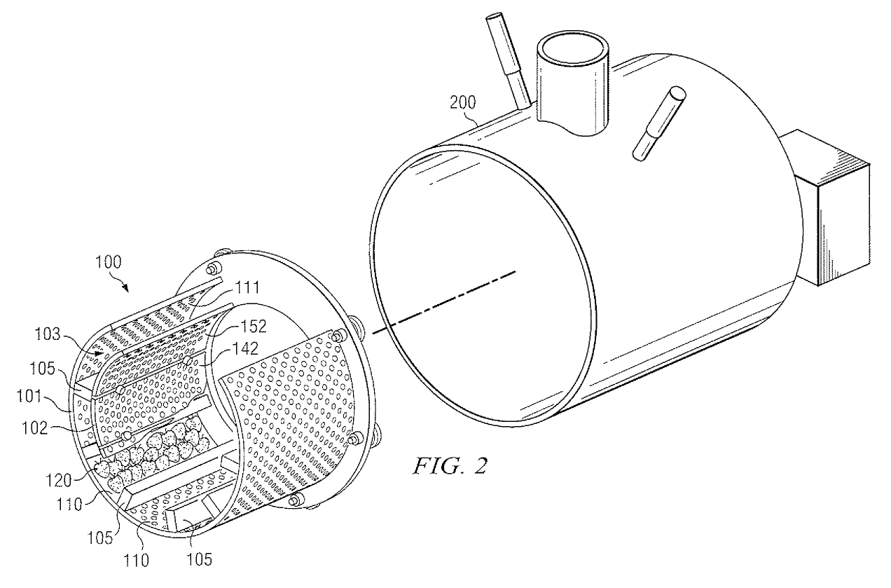

FIG. 2 is an exploded perspective view of a rotatable carousel 100 for placement in the cavity of a vacuum microwave 200 in accordance with one embodiment of the present invention. In one embodiment, the rotatable carousel 100 comprises a plurality of dividers 105 disposed between a first concentric cylinder 101 having an outer diameter and a second concentric cylinder 102 having an inner diameter that define a plurality of compartments 110 disposed within the annular region 103. In one embodiment, the term “divider” is an object that separates the annular region 103 into compartments 110 so as to provide circumferential disposition of the food product within the annular region 103. The divider can be straight, actuate, or serpentine. The divider can also be solid or perforated. In one embodiment, the dividers 105 are oriented radially around the longitudinal axis of the carousel 100 in the annular region 103 between the first concentric cylinder 101 and the second concentric cylinder 102. As used herein, the term “annular region” is defined as the area that provides for circumferential disposition of food product inside the outer circumference of the rotatable carousel 100. In one embodiment, the annular region 103 comprises the area within the carousel 100 between the first concentric cylinder 101 and the second concentric cylinder 102. The Figures shown herein are provided for purposes of illustration and not limitation. Other embodiments can be used in accordance with the spirit and scope of the present invention. In the embodiment shown, the removable coverings 142 152, which facilitate loading and unloading of food pieces 120, form the second concentric cylinder 102. In one embodiment (not shown), the first concentric cylinder and second concentric cylinder each comprise removable coverings. In one embodiment (not shown), only the first concentric cylinder comprises removable coverings.

The concentric cylinders 101 102 can be selected from any material suitable for use in a microwave. The material can be perforated or unperforated, however, a perforated material permits steam that is formed during the dehydration process to be more easily removed from the compartment 110. Thus, in one embodiment, one or both cylinders 101 102 comprises a plurality of perforations. In one embodiment, one or both cylinders 101 102 comprises a perforated polypropylene.

In one embodiment, a portion of the second concentric cylinder 102 is removed (e.g., a first removable covering 152 is removed), food pieces 120 are placed into the respective compartment 110, and the removed portion of the second concentric cylinder 102 is replaced (e.g., the removable covering 152 is reattached) after the compartment is loaded with food pieces 120. This process can be repeated with other portions of the second concentric cylinder 102 that cover the other compartments 110 until the desired number of compartments 110 contains food product. The carousel 100 can then be placed into the vacuum microwave 200.

Microwave energy essentially heats a food product from the inside outward. As food pieces 120 are dehydrated in the vacuum microwave 200, the food piece surfaces can become sticky as a result of the moisture that migrates from the interior to the boundary of the food pieces 120. Consequently, in one embodiment, the concentric cylinders 101 102 and dividers 105 comprise a non-stick material such as a fluoropolymer to prevent the food pieces 120 from sticking to the cylinders 101 102 and dividers 105.

In one embodiment, a compartment 110 is loaded with food pieces 120 to create a food volume that leaves enough void volume in the compartment to permit the food pieces 120 to move when the carousel 100 is rotated. In one embodiment of the present invention, the compartments 110 are loaded such that the food pieces 120 have sufficient movement within the compartment 110 during carousel rotation to avoid sticking to any portion of the carousel 100 including the cylinders 101 102 and dividers 105, and to avoid sticking to any adjacent food pieces 120. Sufficient movement of the pieces 120 advantageously limits the time any portion of the outer surface area of the food piece 120 is in contact with an adjacent food piece or a portion of the carousel 100. Consequently, sufficient movement permits moisture to escape from entire outer circumferential periphery of the food piece 120 and reduces stickiness.

In one embodiment, stickiness of the food product is further minimized by applying a non-stick coating, such as by spraying oil to the outer surface of the food pieces 120 and/or the compartment side portions of the cylinders 101 102 and the dividers 105 of the carousel 100.

Food pieces 120 that can be used in accordance with the present invention include, but are not limited to whole or cut pieces of apple, strawberry, blueberry, and melons. Whole strawberries used in accordance with the present invention have yielded a highly desirable, low-moisture shelf-stable food product. As used herein, a shelf-stable food comprises a moisture content of less than about 8% by weight and more preferably between about 2% about 5% by weight. In one embodiment, the food comprises a moisture content of less than about 2% by weight. In one embodiment, the food pieces 120 comprise food pieces cut into halves or quarters from the whole. Some food products may need processing prior to placement into the carousel 100. For example, some fruits such as berries, including grapes, naturally have waxy cuticle on the epidermis to slow the loss of water through evaporation. Thus, some food products can be treated by methods well known in the art (e.g., see U.S. Pat. No. 7,119,261 at col. 1, lines 48-60) to modify the waxy cuticle so that transpiration of water vapor across the cuticle may proceed at a faster rate when in the microwave. In one embodiment, blueberries were sprayed with PAM brand oil to help de-lipify the waxy cuticle surface.

Similarly, oranges are preferably peeled prior to dehydration. Because banana slices are often very sticky, bananas can be cut into ball-shaped spheres to minimize the available surface area for contact between ball-shaped pieces as well as between the ball-shaped pieces and the carousel 100. Sufficient movement within the carousel 100 during dehydration can prevent the banana pieces from sticking together. It is contemplated that food products including, but not limited to peach, nectarine, grape, pineapple, mango, avocado, and raspberry can also be used. Like banana, some food products such as peach, nectarine, and mango may benefit from being cut into a spherical-shaped piece prior to insertion into the carousel 100.

In one embodiment, the rotational direction of the carousel 100 within the microwave is unidirectional e.g., always clockwise or counter-clockwise when the carousel 100 is in the vacuum microwave 200. In one embodiment, the carousel rotation oscillates between a first direction and a second direction. For example, the carousel 100 can rotate a first number of degrees (e.g. 120 degrees, 360 degrees) in a first direction (e.g. clockwise direction) and then a second number of degrees (e.g. 30 degrees, 60 degrees) in a second direction (e.g. the counter-clockwise direction). In one embodiment, the carousel 100 rotates the same number of degrees in both the clockwise and counterclockwise direction.

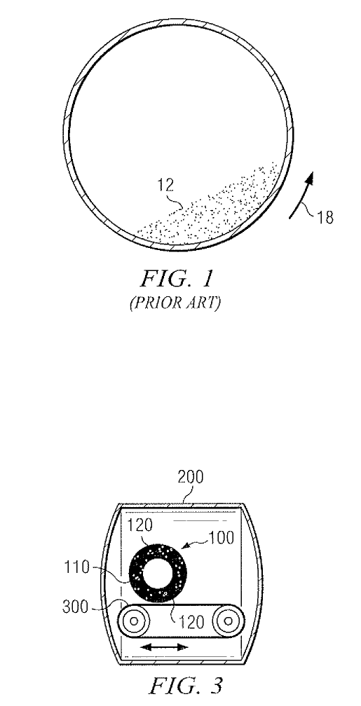

The compartments 110 disposed in the annular region 103 of the carousel 100 provide circumferential disposition of the food product. One advantage to placing the food product into the annular region 103 is that, unlike the product 12 shown in FIG. 1 that uses only a portion of the full perimeter of the vacuum microwave and has an uneven bed depth due to its semi-circular configuration, the present invention can use the full outer perimeter of the vacuum microwave drum. Consequently, to the extent the microwave power density is radially uniform, heating of the food pieces 120 depicted in FIG. 2 is more uniform because the food pieces 120 are exposed to substantially the same microwave power density within the compartments 110 of the vacuum microwave oven. Further, heating is more uniform because the compartments 110 provide an even bed depth of food pieces 120.

Another advantage of placing the food product into the compartments 110 in the annular region 103 is that the food pieces 120 can be gently moved upon rotation of the carousel 100. The carousel 100 is preferably rotated at a rate that imparts sufficient movement of the food pieces 120 such that the food pieces 120 avoid sticking to one another or to any portion of the annular compartments 110. Movement of the food pieces 120 at too high speed, however, can cause undesirable collision damage to the food pieces 120, which can result in undesirable compaction. Undesirable compaction occurs when the microstructure of the food pieces 120 breaks down and can cause the food piece 120 to collapse when the vacuum is released at the end of the drying cycle. Thus, the food pieces 120 need to be moved in a gentle manner so as to avoid undesirable compaction. The desired rotational speed will be dependent upon several factors including the type of food being processed, the stickiness of the food being processed, whether the food being processed has been cut into smaller pieces, the power of the microwave, and any processing that is done that reduces stickiness, such as pre-drying or oil addition. Given this disclosure, one skilled in the art will be able to determine the appropriate compartment size and rotational speed for a corresponding food product.

The food product can be removed from the vacuum microwave based one or more factors including, but not limited to, a rise in an internal drum temperature provided by an infrared camera or other suitable measuring device, a predetermined time based upon type of food product and weight of food product, humidity level, or amount of reflective energy measured in the vacuum microwave drum. The present invention thereby provides an improved apparatus and method for making a vacuum microwaved food product.

FIG. 3 is a cut away side view of a vacuum microwave 200 having a carousel 100 that rotates about the transverse axis of the vacuum microwave drum 200 in accordance with one embodiment of the present invention. This embodiment demonstrates another configuration in which the carousel 100 can be used. A carousel 100 having food product in annular compartments 110 is placed onto an endless conveyor belt 300 in a vacuum microwave 200. Operation of the belt 300 can cause the carousel 100 to be continuously rotated. The direction of travel of the endless belt 300 can be changed as desired to change the rotational direction of the carousel 100.

One embodiment of the invention is illustrated in the example set forth below, where reference to the carousel illustrated in FIG. 2 is intended to be exemplary, not limiting:

### EXAMPLE

About 8 pounds of whole strawberries were washed and drained. A 25% sugar solution was used to provide a more ripened flavor in the finished product. However, this step is optional and if ripe strawberries are used, a sugar solution is not necessary. The compartment side of the cylinders 101 102 and strawberries were sprayed with PAM brand oil to prevent the strawberries from sticking to one another. The carousel first concentric cylinder 101 had an outer annular diameter of about 15 inches and the second concentric cylinder 102 had an inner annular diameter of about 11.5 inches. Each concentric cylinder 101 102 had a length of about 15 inches. The carousel 100 had six evenly spaced compartments. The six compartments 110 were defined by dividers 105 oriented radially around the longitudinal axis of the carousel 100 in the annular region 103 between the first 101 and second concentric cylinders 102. Five of the chambers were each filled with about 1.5 pounds of strawberries and the first 101 and second 102 concentric cylinders comprised perforated polypropylene. The carousel 100 was placed inside a model 0650 μWaveVac vacuum microwave oven 200 sold by Pueschner of Schwanewede, Germany.

The strawberries were then dehydrated under vacuum. Initially, drying occurred at a microwave power of about 4 kilowatts, which corresponded to about 2.7 kilowatts absorbed by the strawberries. The carousel 100 was rotated in an oscillating format—the carousel rotated about 120 degrees each direction using speed setting of about 5.0 revolutions per minute. The pressure inside the microwave was maintained at about 30 torr. About 100% of the infrared heat available was used throughout drying process. When the infrared camera mounted to read the temperature inside the microwave drum indicated a temperature range of about 105° F. to about 110° F., the microwave power was reduced to and maintained at about 3 kilowatts until reaching an internal temperature range of about 105° F. to about 110° F., at which point the microwave power was reduced to about 2 KW, then to about 1.0 KW until reaching an internal drum temperature range of about 105° F. to about 110° F., and finally to about 0.5 KW until an internal drum temperature of about 150° F. was indicated and the vacuum microwave oven was turned off. The total drying time was about 50 minutes, and the finished dried strawberries weighed about 0.80 lbs and had a shelf-stable moisture content of about 4% by weight. A hand held infrared thermometer measured a strawberry surface temperature of about 172° F. when the drum was opened after processing. The temperature difference between the strawberry and the internal drum temperature is likely because the infrared camera mounted to measure the inside temperature of the drum is likely measuring the temperature of the first concentric cylinder 101. Because the strawberries were dehydrated under vacuum, the finished shape of each strawberry is approximately the same as its initial starting shape although there is some volumetric shrinkage.

Although the example above was conducted on a pilot scale using only 5 out of 6 compartments on a single carousel, such proof of principle indicates that scalability is possible. It is believed that, for example, a larger carousel can be used that can handle about 130 pounds of raw fruit per batch resulting in about 20 pounds of finished product. Utilizing 8 of these carousels in a batch or semi-continuous operation would result in about 160 pounds per hour of dried whole strawberries, which is over about 2,590 28-gram servings.

The present invention has several advantages over the prior art. In one embodiment, the present invention permits vacuum microwave drying to be performed in compartments in an annular region so as to minimize collision forces, establish uniform bed depths, and increase the available capacity in a vacuum microwave drum. In one embodiment, the present invention avoids clumping of food pieces and increases the exposure to microwaves. The present invention permits the bulk handling of vacuum microwave food products and provides an opportunity for easier automation.

While this invention has been particularly shown and described with reference to a preferred embodiment, it will be understood by those skilled in the art that various changes in form and detail may be made therein without departing from the spirit and scope of the invention. For example, in one embodiment, another heat source such as infrared heat and can be applied before, during, or after the microwave energy is applied to the food product.

What is claimed is:

1. A method for dehydrating a food product comprising:
providing a carousel having an annular region, wherein said annular region further comprises a plurality of compartments;
loading said compartments with a food product; and
dehydrating said food product in said compartments in a vacuum microwave wherein said carousel rotates during said dehydration.

2. The method of claim 1 wherein said food product comprises one or more foods selected from strawberry, apple, and blueberry.

3. The method of claim 1 wherein said food product comprises one or more foods selected from peach, banana, nectarine, pineapple, mango, avocado, raspberry, blueberry, grape, peeled orange, and melons.

4. The method of claim 1 wherein said carousel comprises a first concentric cylinder and a second concentric cylinder defining the annular region.

5. The method of claim 4 wherein said first or said second concentric cylinder comprises perforations.

6. The method of claim 4 further comprising a plurality of dividers disposed between said first concentric cylinder and said second concentric cylinder to define said plurality of compartments.

7. The method of claim 1 wherein said carousel rotates in an oscillating manner.

8. The method of claim 1 wherein said food product is coated with oil.

9. The method of claim 1 wherein said compartments are coated with oil.

10. The method of claim 1 wherein said food product is dehydrated to a shelf-stable moisture content.

11. The method of claim 1 wherein said food product further comprises a plurality of food pieces, and wherein said carousel is rotated at a rotational speed that provides movement to said food pieces.

12. A vacuum microwave device comprising:
a vacuum microwave having a cavity; and
a rotatable carousel having a first concentric cylinder and a second concentric cylinder defining an annular region there between;
a plurality of dividers disposed in said annular region thereby defining a plurality of compartments, wherein said rotatable carousel can rotate within said cavity of said vacuum microwave.

13. The vacuum microwave device of claim 12 wherein said first concentric cylinder comprises a removable covering.

14. The vacuum microwave device of claim 12 wherein said second concentric cylinder comprises a removable covering.

15. The vacuum microwave device of claim 12 wherein said first concentric cylinder comprises perforations.

16. The vacuum microwave device of claim 12 wherein said second concentric cylinder comprises perforations.
